(19) United States
(12) Patent Application Publication
(10) Pub. No.: US 2011/0290137 A1
(43) Pub. Date: Dec. 1, 2011

(54) IMAGE FORMING APPARATUS

(75) Inventors: Takashi Hatakeyama, Kanagawa-ken (JP); Satoshi Kaiho, Kanagawa-ken (JP); Nobuaki Takahashi, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/118,905

(22) Filed: May 31, 2011

Related U.S. Application Data
(60) Provisional application No. 61/350,286, filed on Jun. 1, 2010.

(51) Int. Cl. B41F 33/00; B65H 85/00

(52) U.S. Cl. 101/483; 271/186

(57) ABSTRACT

According to one embodiment, an image recording apparatus includes a printing unit and an entry angle changing mechanism. The entry angle changing mechanism is disposed further along the upstream than the printing unit in a conveying direction and changes the entry angle of the paper with an upper surface not printed and a lower surface printed, after printing on the first surface if printing on both sides is performed by the printing unit.

### CROSS-REFERENCE TO RELATED APPLICATIONS

This application is based upon and claims the benefit of priority from Provisional Application No. 61/350,286, filed on Jun. 1, 2010, the entire contents of which are incorporated herein by reference.

### FIELD

Embodiments described herein relate generally to an image forming apparatus that capable of printing both sides.

### BACKGROUND

In general, a piece of paper printed with aqueous ink is deformed, that is, curled by the water in the ink. The edge of a piece of paper of which the lower surface is the printed surface and the upper surface is the non-printed surface, is folded upward. In a piece of paper of which the upper surface is the printed surface, curl is prevented from being generated by the own weight.

When single-sided printing is required, the paper is conveyed to a copy receiving tray, with the upper surface being the printed surface. Therefore, the paper is conveyed to the copy receiving tray without being curled in the conveying process. Meanwhile, when double-sided printing is required, the paper is conveyed, with the lower surface being the printed surface and the upper surface being the non-printed surface, in the conveying process. Therefore, the paper is curled.

When the curled paper is received at a second mechanism from a first mechanism, the edge of the paper may come in contact to the edge of the second mechanism. When the reception is not good, problems, such as bending of the paper due to bad conveying of the paper, generation of jam, and bad printing, are generated in the image forming apparatus. Further, the curl that is generated in the paper after printing is generated not only in an inkjet type, but also an electrophotographic type of image forming apparatus.

### BRIEF DESCRIPTION OF THE DRAWINGS

FIG. 1 is a view of an image forming apparatus according to a first embodiment, seen in the transverse direction.

FIGS. 2A and 2B are views of a first entry angle changing mechanism according to the first embodiment, seen in the transverse direction.

FIGS. 3A and 3B are views of a second entry angle changing mechanism according to the first embodiment, seen in the transverse direction.

FIG. 4 is a block diagram illustrating the control of the image forming apparatus according to the first embodiment.

FIG. 5 is a flowchart illustrating a printing operation by the image forming apparatus according to the first embodiment.

FIG. 6 is a flowchart illustrating the control of the second entry angle changing mechanism according to the first embodiment.

FIG. 7 is a flowchart illustrating the control of the first entry angle changing mechanism according to the first embodiment.

FIG. 8 is a flowchart illustrating the control of the first entry angle changing mechanism according to the first embodiment.

FIG. 9 is a view of an image forming apparatus according to a second embodiment, seen from the transverse direction.

### DETAILED DESCRIPTION

In general, according to one embodiment, an image forming apparatus includes a printing unit and entry angle changing mechanism. The entry angle changing mechanism is disposed further along the upstream in the conveying direction than the printing unit and change an entry angle of a piece of paper of which an upper surface is a non-printed surface and an lower surface is a printed surface after the first surface is printed in which double-sided printing is performed by the printing unit.

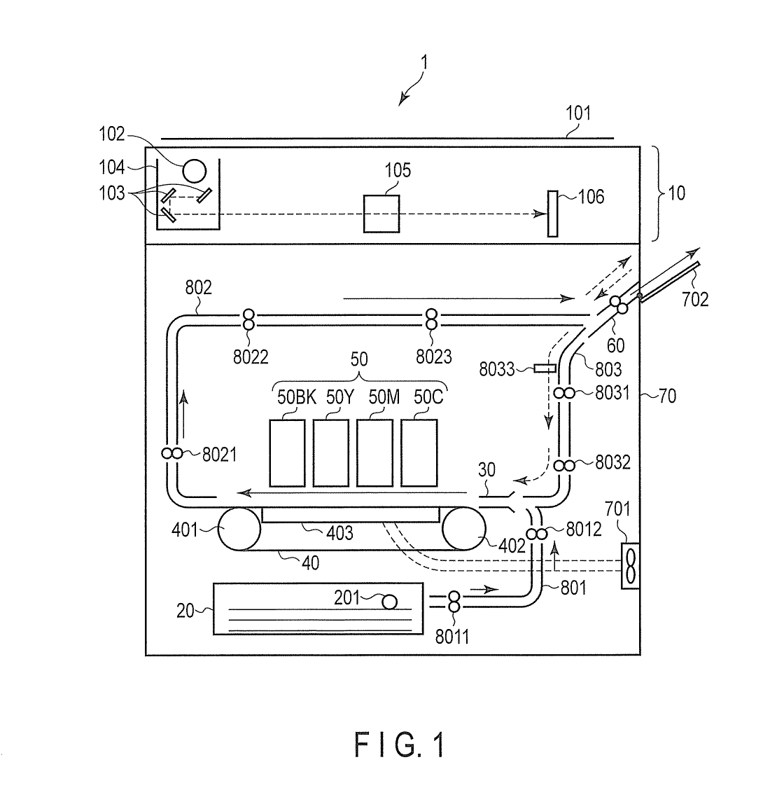

Hereinafter, the embodiment is described with reference to the drawings. Although the embodiment is described by exemplifying an inkjet type of image forming apparatus, it may be applied in the same way to an electrophotographic type of image forming apparatus. FIG. 1 is a view showing an image forming apparatus 1 according to a first embodiment, seen from the transverse direction. The image forming apparatus 1 includes an image reading unit 10, a paper cassette 20, a first entry angle changing mechanism (conveying mechanism) 30, a conveying belt (conveying mechanism) 40, a printing unit 50, a second entry angle changing mechanism (conveying mechanism) 60, a chassis 70, a plurality of conveying guides 801, 802, and 803 and the like. The entire configuration and a double-sided conveying path of the image forming apparatus 1 will be described first and then the first entry angle changing mechanism 30 and the second entry angle changing mechanism 60 will be described.

The image reading unit 10 includes a platen 101, an exposure lamp 102, a reflective mirror 103, a carriage 104, an image lens 105, and a CCD 106.

The paper cassette 20 receives a bundle of paper composed of a plurality of pieces of paper. The paper cassette 20 includes a paper supply roller 201. The paper supply roller 201 is in contact to the uppermost paper of the bundle of paper received in the paper cassette 20. Further, the image forming apparatus 1 includes the conveying guide 801 between a paper discharge side of the paper cassette 20 and the first entry angle changing mechanism 30 such that the paper received in the paper cassette 20 is conveyed to the first entry angle changing mechanism 30. The conveying guide 801 includes a pair of conveying rollers 8011 and a pair of conveying rollers 8012.

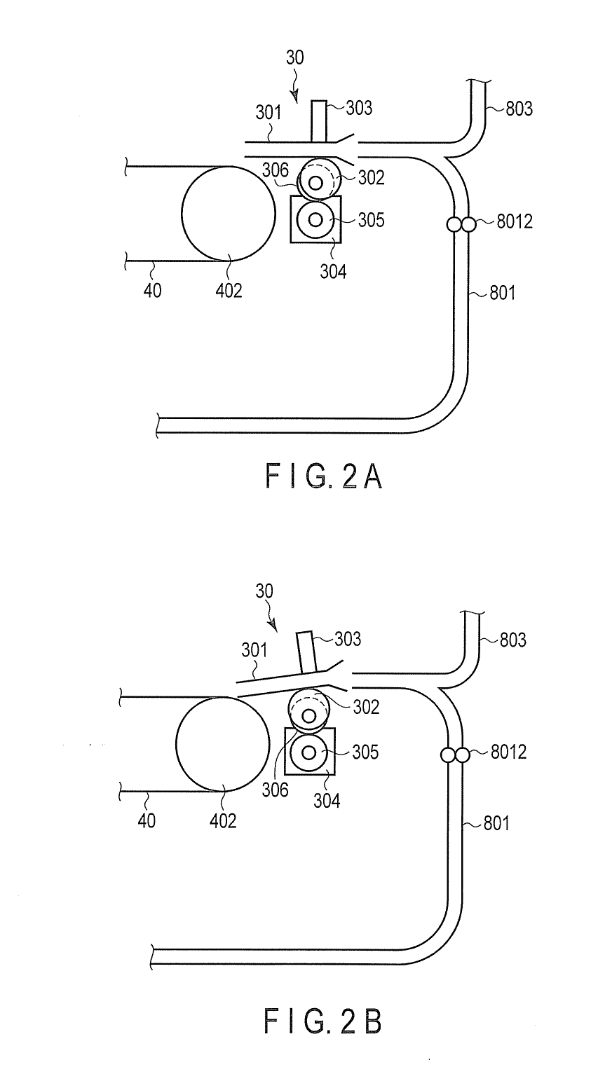

The first entry angle changing mechanism 30 is positioned between the conveying guide 801 and the conveying belt 40, at the upstream of the conveying belt 40 in the conveying direction of the paper. The first entry angle changing mechanism 30 is movable independently from the conveying guide 801 and the conveying belt 40. The configuration of the first entry angle changing mechanism 30 is described below with reference to FIGS. 2A and 2B.

The conveying belt 40 is endlessly hung on a driving roller 401 and a driven roller 402. Tensile force is exerted in the conveying belt 40 by the driving roller 401 and the driven roller 402. A negative pressure chamber 403 is disposed inside the conveying belt 40. The negative pressure chamber 403 is connected to a fan 701 to absorb the paper to the conveying belt 40.

The printing unit 50 is disposed opposite to and above the conveying belt 40. The printing unit 50 includes four inkjet heads 50C, 50M, 50Y, and 50Bk that discharge ink (color material) onto the paper in response to image data. The printing unit 50 includes the inkjet head 50C that discharges cyan (C) ink, the inkjet head 50M that discharges magenta (M) ink, the inkjet head 50Y that discharges yellow (Y) ink, and the inkjet head 50Bk that discharges black (Bk) ink. The printing unit 50 prints the paper, using the inkjet heads 50C, 50M, 50Y, and 50Bk.

The conveying guide 802 is disposed at the downstream of the conveying belt 40 in the conveying direction of the paper. The conveying guide 802 is positioned between the conveying belt 40 and the second entry angle changing mechanism 60. The conveying guide 802 includes a pair of conveying rollers 8021, a pair of conveying rollers 8022, and a pair of conveying rollers 8023.

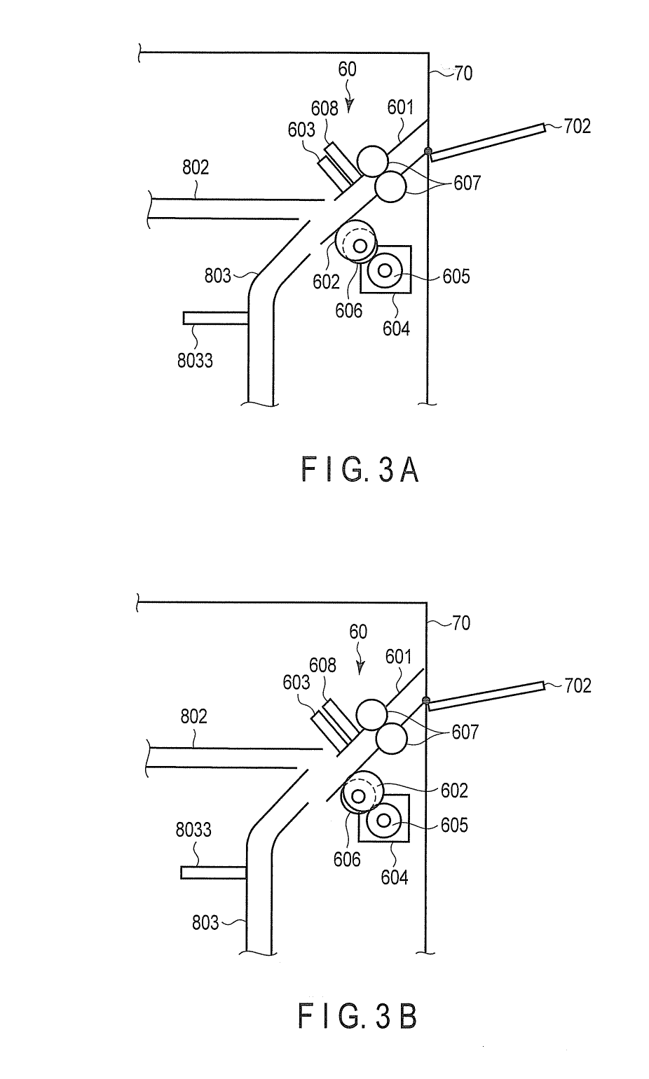

The second entry angle changing mechanism 60 is positioned between the conveying guide 802 and the chassis 70. The second entry angle changing mechanism 60 operates independently from the conveying guide 802. The configuration of the second entry angle changing mechanism 60 is described below with reference to FIGS. 3A and 3B. A copy receiving tray 702 is disposed adjacent to the second entry angle changing mechanism 60 and outside the chassis 70. The copy receiving tray 702 sequentially stacks and receives paper with one side or both sides printed, which is discharged from the second entry angle changing mechanism 60.

The conveying guide (conveying mechanism) 803, as a conveying path for double-sided printing, is disposed between the second entry angle changing mechanism 60 and the first entry angle changing mechanism 30. The conveying guide 803 is in contact to the conveying guide 801, at the first entry angle changing mechanism 30. The conveying guide 803 includes a pair of conveying rollers 8031, a pair of conveying rollers 8032, and a first sensor 8033. The first sensor 8033 detects that the paper is present within a detection area.

Next, the configuration of the first entry angle changing mechanism 30 is described with reference to FIGS. 2A and 2B. FIGS. 2A and 2B are views of the first entry angle changing mechanism 30, seen in the transverse direction. FIGS. 2A and 2B show the states in which the movable type of first entry angle changing mechanism 30 is disposed at different positions.

The first entry angle changing mechanism 30 includes a conveying guide 301, an eccentric cam 302, a compression spring 303, a first entry angle changing motor 304, a gear 305, and a gear 306. The conveying guide 301 is positioned between the conveying guide 801 and the conveying belt 40, at the upstream of the printing unit 50 in the conveying direction of the paper. The eccentric cam 302 is disposed under the conveying guide 301. The eccentric cam 302 supports the conveying guide 301. Further, the position of the eccentric cam 302 disposed with respect to the conveying guide 301 is not limited. The compression spring 303 is disposed opposite to the eccentric cam 302, with the conveying guide 301 therebetween. The compression spring 303 has elasticity in the direction in which the conveying guide 301 is pressed against the eccentric cam 302.

The first entry angle changing motor 304 has the gear 305 fitted on the shaft. The first entry angle changing motor 304 rotates the gear 305. The gear 306 is engaged with the gear 305. Further, the gear 306 is fitted on the shaft of the eccentric cam 302. The eccentric cam 302 is rotated by the gear 305 and the gear 306, when the first entry angle changing motor 304 is rotated. The rotational position of the shaft of the eccentric cam 302 is moved by the rotation of the first entry angle changing motor 304. The entry angle of the paper for the conveying belt 40, from the outlet of the conveying guide 301, is changed by the movement of the eccentric cam 302. In the first embodiment, when the paper is delivered from the conveying guide 801 (first mechanism) to the first entry angle changing mechanism 30 (second mechanism), the angle where the conveying direction to the outlet of the first mechanism crosses with respect to the conveying direction to the inlet of the second mechanism is defined as the entry angle. That is, the angle where the conveying direction to the outlet of the conveying guide 301 crosses with respect to the conveying direction (horizontal direction) to the conveying belt 40 is determined as a first entry angle.

In FIG. 2A, the conveying direction to the outlet of the first entry angle changing mechanism 30 is the horizontal direction, substantially the same as the conveying direction to the conveying belt 40. That is, the angle where the conveying direction to the outlet of the conveying guide 301 crosses with respect to the conveying direction to the conveying belt 40 is 0 degrees. Therefore, the first entry angle is approximately 0 degrees. Further, as shown in FIG. 2A, the position of the first entry angle changing mechanism 30 where the first entry angle becomes approximately 0 degrees by the movement of the eccentric cam 302 is defined as a position A.

In FIG. 2B, the conveying direction to the outlet of the first entry angle changing mechanism 30 is the direction where it crosses with respect to the conveying direction to the conveying belt 40. That is, the angle where the conveying direction to the outlet of the conveying guide 301 crosses with respect to the conveying direction to the conveying belt 40 is a predetermined value larger than 0 degrees. Therefore, the first entry angle is a predetermined value larger than 0 degrees. Further, as shown in FIG. 2B, the position of the first entry angle changing mechanism 30 where the first entry angle becomes a predetermined value larger than 0 degrees by the movement of the eccentric cam 302 is defined as a position B.

Next, the configuration of the second entry angle changing mechanism 60 is described with reference to FIGS. 3A and 3B. FIGS. 3A and 3B are views of the second entry angle changing mechanism 60, seen from the transverse direction. FIGS. 3A and 3B show when the movable type of second entry angle changing mechanisms 60 is disposed at different positions.

The second entry angle changing mechanism 60 includes a conveying guide 601, an eccentric cam 602, a compression spring 603, a second entry angle changing motor 604, a gear 605, a gear 606, a pair of paper discharge rollers 607, and a second sensor 608. The conveying guide 601 is positioned between the conveying guide 802 or the conveying guide 803 and the chassis 70. The conveying guide 601 is movable on the position where it is in contact to the chassis 70 as a pivot. The eccentric cam 602 is disposed under the conveying guide 601. The eccentric cam 602 supports the conveying guide 601. Further, the position of the eccentric cam 602 disposed with respect to the conveying guide 601 is not limited. The compression spring 603 is disposed opposite to the eccentric cam 602, with the conveying guide 601 therebetween. The compression spring 603 has elasticity in the direction in which the conveying guide 601 is pressed against the eccentric cam 602.

The second entry angle changing motor 604 has the gear 605 fitted on the shaft. The second entry angle changing motor 604 rotates the gear 605. The gear 606 is engaged with the gear 605. Further, the gear 606 is fitted on the shaft of the eccentric cam 602. The eccentric cam 602 is rotated by the gear 605 and the gear 606, when the second entry angle changing motor 604 is rotated. The rotational position of the shaft of the eccentric cam 602 is moved by the rotation of the second entry angle changing motor 604. The entry angle of the paper from the outlet of the conveying guide 601 with respect to the inlet of the conveying guide 803 is changed by the movement of the eccentric cam 602. In the first embodiment, the angle where the conveying direction to the outlet of the conveying guide 601 crosses with respect to the conveying direction to the inlet of the conveying guide 803 is defined as a second entry angle. The second sensor 608 is disposed on the conveying guide 601.

In FIG. 3A, the conveying direction to the outlet of the second entry angle changing mechanism 60 is the same as the conveying direction to inlet of the conveying guide 803. That is, the angle where the conveying direction to the outlet of the conveying guide 601 crosses with respect to the conveying direction to the inlet of the conveying guide 803 is 0 degrees. Therefore, the second entry angle is approximately 0 degrees. Further, as shown in FIG. 3A, the position of the second entry angle changing mechanism 60 where the second entry angle becomes approximately 0 degrees by the movement of the eccentric cam 602 is defined as a position C.

In FIG. 3B, the conveying direction to the outlet of the second entry angle changing mechanism 60 is the direction where it crosses with respect to the conveying direction to the inlet of the conveying guide 803. That is, the angle where the conveying direction to the outlet of the conveying guide 601 crosses with respect to the conveying direction to the inlet of the conveying guide 803 is a predetermined value larger than 0 degrees. Therefore, the second entry angle is a predetermined value larger than 0 degrees. Further, as shown in FIG. 3B, the position of the second entry angle changing mechanism 60 where the second entry angle becomes a predetermined value larger than 0 degrees by the movement of the eccentric cam 602 is defined as a position D.

The pair of paper discharge rollers 607 is provided to convey the paper from the inside of the chassis 70 to the conveying guide 803. The second sensor 628 detects that the paper is present within a detection area.

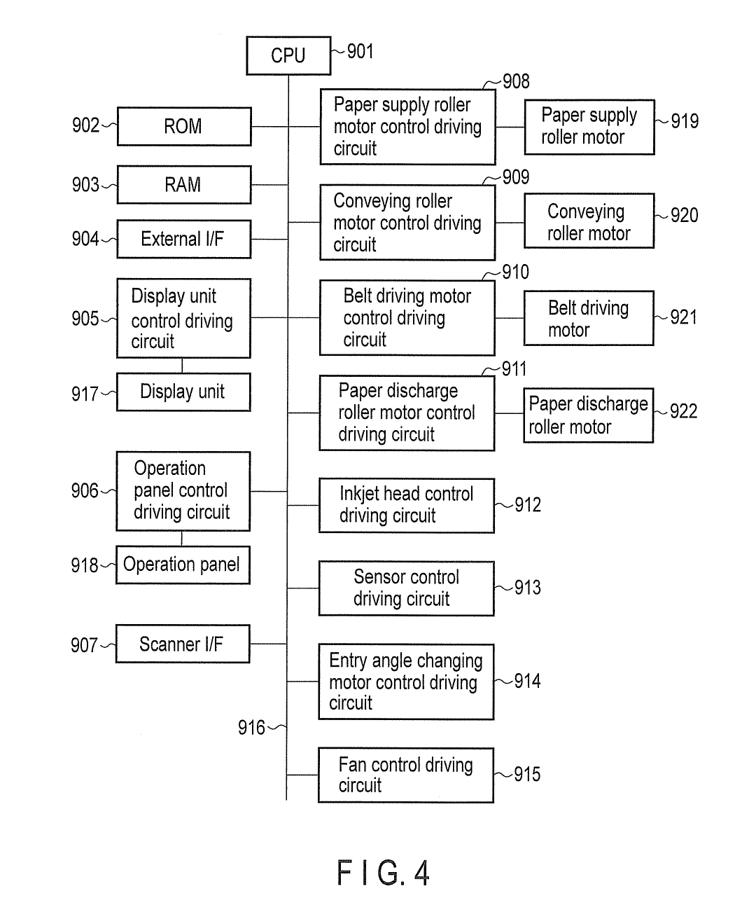

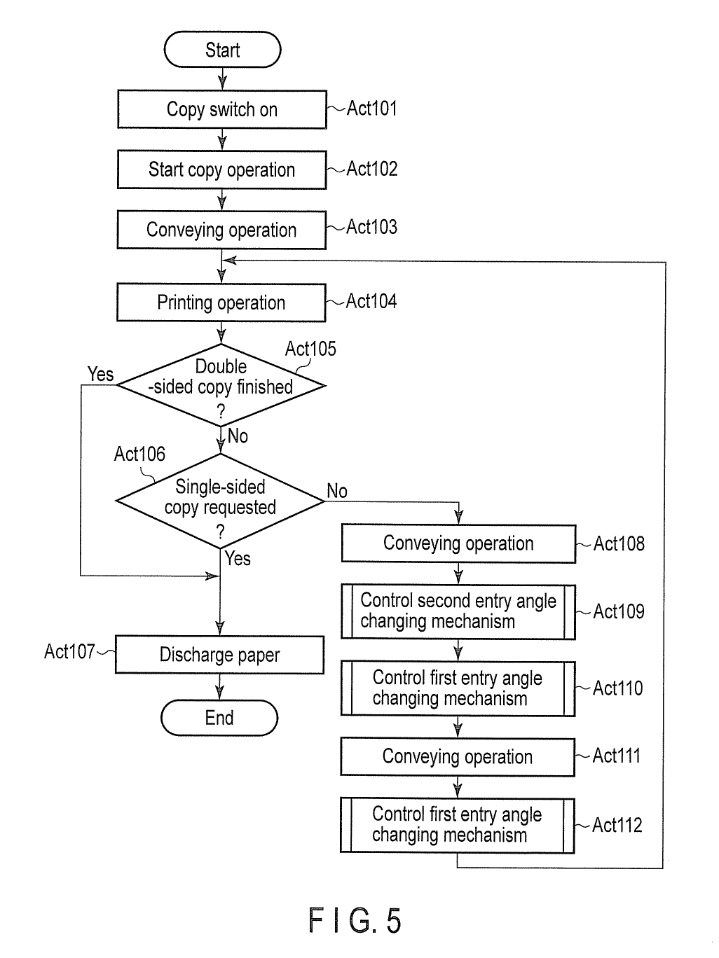

Next, a control system of the image forming apparatus 1 according to the first embodiment is described with reference to FIG. 4. The image forming apparatus 1 includes a CPU (controller) 901, a ROM 902, a RAM 903, an external I/F 904, a display unit control driving circuit 905, an operation panel control driving circuit 906, a scanner I/F 907, a paper supply roller motor control driving circuit 908, a conveying roller motor control driving circuit 909, a belt driving motor control circuit 910, a paper discharge roller motor control driving circuit 911, an inkjet head control driving circuit 912, sensor control driving circuit 913, an entry angle changing motor control driving circuit 914, and a fan control driving circuit 915.

The CPU 901 controls the operation of the parts connected through a CPU bus 916. The ROM 902 maintains various programs that are executed by the CPU 901. The RAM 903 maintains a variety of data. The RAM 903 maintains first information showing the relationship between a printing ratio and the amount of curl. The printing ratio is the proportion of a substantially printed area to the printing area of the paper. The amount of curl is defined as the size in the height direction from the lower end (usually the center) to the upper end (usually the edge) of the paper. The first information can be acquired by measuring the amount of curl of the paper of which the printed surface is the lower surface and the non-printed surface is the upper surface by changing the printing ratio of a solid image. The higher the printing ratio, the larger the amount of curl becomes.

The external I/F 904 connect an external computer with the CPU bus 916. The external I/F 904 receives a printing instruction and image data for the image forming apparatus 1 from the external computer. The display unit control driving circuit 905 controls displaying of a variety of information on a display unit 917 under the control of the CPU 901. The display unit 917 displays the variety of information. The operation panel control driving circuit 906 controls the driving of an operation panel 918 under the control of the CPU 901. The operation panel 918 receives an input from a user. The scanner I/F 907 inputs read image information read by the CCD 106. The paper supply roller motor control driving circuit 908 controls the driving of a paper supply roller motor 919 under the control of the CPU 901. The paper supply roller motor 919 drives the paper supply roller 201. The conveying roller motor control driving circuit 909 controls the driving of a conveying roller motor 920 under the control of the CPU 901. The conveying roller motor 920 independently drives the pair of conveying rollers 8011, the pair of conveying rollers 8012, the pair of conveying rollers 8021, the pair of conveying rollers 8022, the pair of conveying rollers 8023, the pair of conveying rollers 8031, and the pair of conveying rollers 8032. The belt driving motor control circuit 910 controls the driving of a belt driving motor 921 under the control of the CPU 901. The belt driving motor 921 drives the driving roller 401.

The paper discharge roller motor control driving circuit 911 controls the driving of a paper discharge roller motor 922 under the control of the CPU 901. The paper discharge roller motor 922 controls the driving of the pair of paper discharge rollers 607. In the first embodiment, the rotation of the pair of paper discharge rollers 607 in which the paper is conveyed from the second entry angle changing mechanism 60 to the copy receiving tray 702 under the control of the CPU 901 is defined as forward rotation. On the contrary, the rotation of the pair of paper discharge rollers 607 in which the paper is conveyed from the second entry angle changing mechanism 60 to the conveying guide 803 under the control of the CPU 901 is defined as backward rotation. The inkjet head control driving circuit 912 synchronizes the operation of conveying the paper by the conveying belt 40 and controls the discharge of ink from the inkjet heads 50C, 50M, 50Y, and 50Bk, on the basis of the image data, under the control of the CPU 901. The sensor control driving circuit 913 controls the driving of a first sensor 8033 and a second sensor 608 under the control of the CPU 901. The entry angle changing motor control driving circuit 914 independently controls the driving of a first entry angle changing motor 304 and a second entry angle changing motor 604, under the control of the CPU 901. The fan control driving circuit 915 controls the driving of a fan 701 under the control of the CPU 901. The length from the first sensor 8033 to the first entry angle changing mechanism is a gap larger than the conveying-directional length of the paper cassette 20.

FIG. 5 is a flowchart illustrating the printing operation of the image forming apparatus 1. Further, the first entry angle changing mechanism 30 is at the position A, as the initial position, and the second entry angle changing mechanism 60 is at the position C, when printing is started. First, the CPU 901 detects input of copy switch-ON to the operation panel 918 by a user (Act 101). The CPU 901 performs control such that a copy operation is started (Act 102). The CPU 901, in Act 102, reads the image data with the image read reading unit 10 and sends a printing instruction to the printing unit 50.

The CPU 901 starts the operation of conveying the paper (Act 103). In Act 103, the CPU 901 performs control to take the uppermost paper in the bundle of paper received in the paper cassette 20, using the paper supply roller 201. The CPU 901 performs control such that the paper taken by the paper supply roller 201 is supplied to the conveying belt 40 through the conveying guide 801 and the first entry angle changing mechanism 30, by using the pair of conveying rollers 8011 and the pair of conveying rollers 8012.

Next, the CPU 901 starts the printing operation (Act 104). In Act 104, the CPU 901 synchronizes the operation of conveying the paper by the conveying belt 40 and controls the printing unit 50 to print on the surface of the paper on the basis of the image data. The CPU 901 determines whether the double-sided copy is finished or not (Act 105). The CPU 901 determines whether the single-sided copy is requested or not, as a printing instruction (Act 106), when it is determined that the double-sided copy is finished (Act 105, No).

The CPU 901 performs control such that the paper printed by the printing unit 50 is discharged to the copy receiving tray 702 (Act 107), when determining that the single-sided copy is requested as a printing instruction (Act 106, Yes). In Act 107, the CPU 901 performs control such that the paper is discharged to the copy receiving tray 702 through the conveying guide 802 and the second entry angle changing mechanism 60, by using the pair of conveying rollers 8021, the pair of conveying rollers 8022, the pair of conveying rollers 8023, and the pair of paper discharge rollers 607. The CPU 901 finishes the copy operation through the operations described above. The CPU 901 performs control such that the operation of Act 108 is performed, when determining that the double-sided copy is finished (Act 105, Yes).

The CPU 901 performs control such that the paper printed by the printing unit 50 is conveyed to the second entry angle changing mechanism 60 (Act 108), when determining that the single-sided copy is not requested as a printing instruction (that is, determining that the double-sided copy is requested) (Act 106, No). In Act 108, the CPU 901 performs control such that the paper is conveyed to the second entry angle changing mechanism 60 through the conveying guide 802, by using the pair of conveying rollers 8021, the pair of conveying rollers 8022, and the pair of conveying rollers 8023. The lower surface of the paper that is conveyed inside the conveying guide 601 is the printed surface (first surface) and the upper surface is the non-printed surface (second surface). Accordingly, the paper is curled.

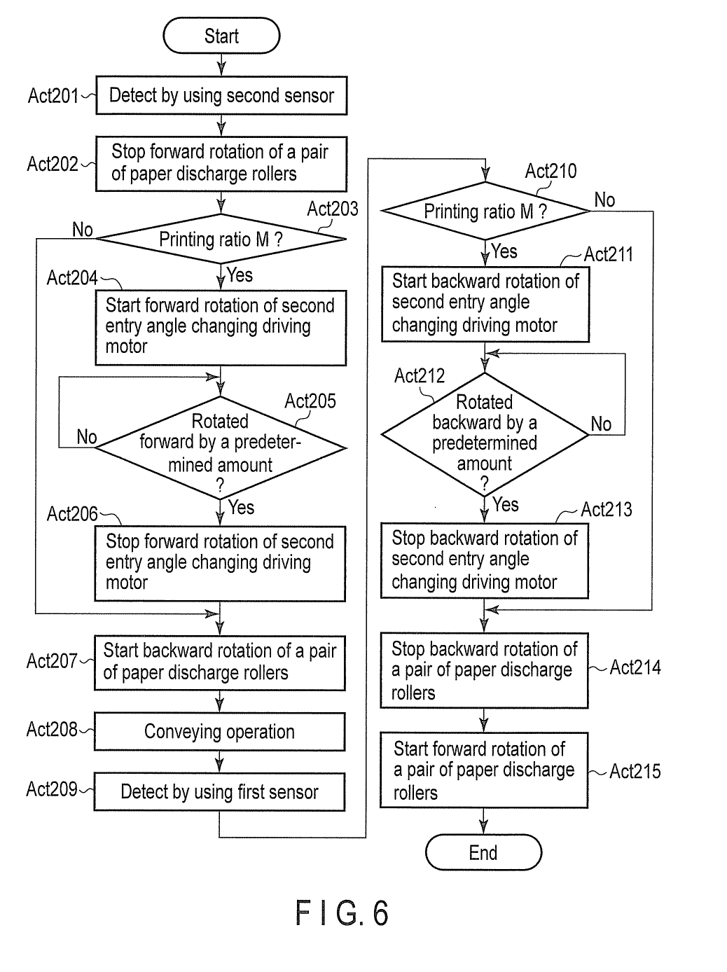

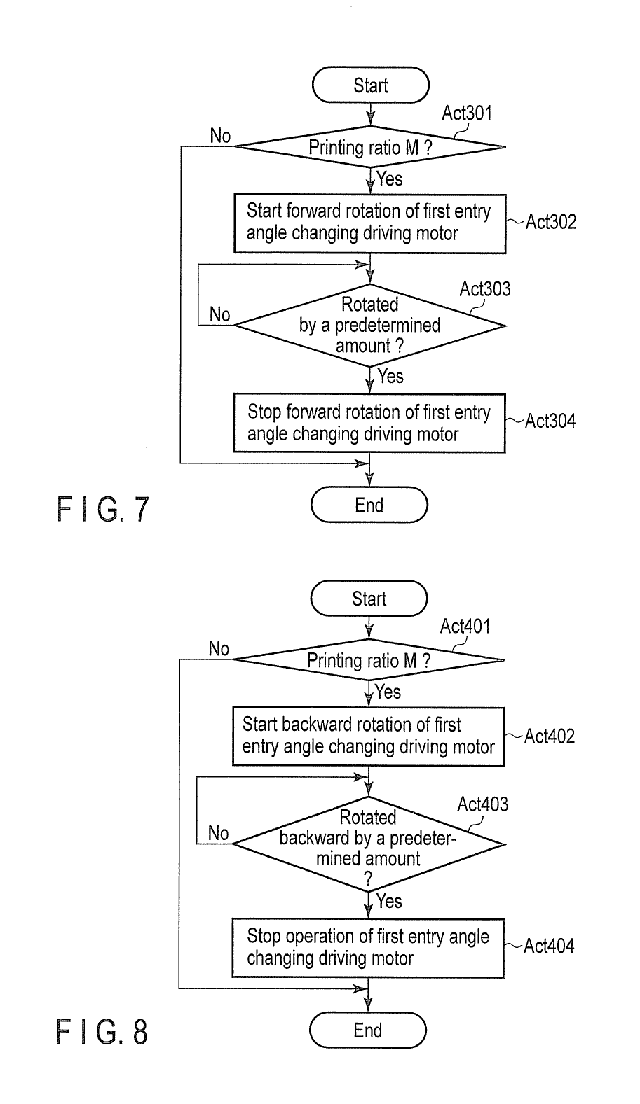

Thereafter, the CPU 901 controls the position of the second entry angle changing mechanism 60 (Act 109). The control of the position of the second entry angle changing mechanism 60 in Act 109 is described below with reference to FIG. 6. Thereafter, the CPU 901 controls the position of the first entry angle changing mechanism 30 (Act 110). The control of the position of the first entry angle changing mechanism 30 in Act 110 is described below with reference to FIG. 7. Thereafter, the CPU 901 performs control such that paper is conveyed from the first entry angle changing mechanism 30 to the conveying belt 40 (Act 111). The lower surface of the paper that is conveyed from the first entry angle changing mechanism 30 to the conveying belt 40 is the printed surface (first surface) and the upper surface is the non-printed surface (second surface). Thereafter, the CPU 901 controls the position of the first entry angle changing mechanism 30 (Act 112). The control of the position of the first entry angle changing mechanism 30 in Act 112 is described below with reference to FIG. 8. Thereafter, the CPU 901 returns to Act 104 and controls the printing operation of the printing unit 50.

Further, in Act 101, the CPU 901 performs control such that printing is performed on the basis of the image data read by the image reading unit 10, but it may perform control such that printing is performed on the basis of the image data acquired through the external I/F 904.

FIG. 6 is a flowchart illustrating the control of the position of the second entry angle changing mechanism 60 in Act 109. First, the CPU 901 acquires detection information by the second sensor 608 (Act 201). In Act 201, the CPU 901 determines whether the paper is present in the detection area of the second sensor 608 on the basis of the detection information by the second sensor 608. That is, the CPU 901 determines that the rear end of the paper is conveyed inside the conveying guide 601, when the second sensor 608 cannot detect the paper.

The CPU 901 controls the pair of paper discharge rollers 607 to stop forward rotation, when determining that the second sensor 608 cannot detect the paper (Act 202). The CPU 901 determines whether the printing ratio of the first surface is larger than a reference value M, on the basis of the image data (Act 203). Further, the reference value M is arbitrarily variable for the operation panel 918. The CPU 901 controls the second entry angle changing motor 604 to start to rotate forward (Act 204), when the printing ratio is larger than the reference value M (Act 203, Yes). In the first embodiment, the rotation of the second entry angle changing motor 604 in which the second entry angle changing mechanism 60 moves from the position C to the position D is determined as forward rotation. That is, the CPU 901 performs control such that the second entry angle is changed, by moving the eccentric cam 602.

The CPU 901 determines whether the second entry angle changing motor 604 performs a predetermined amount of forward rotation (Act 205). The CPU 901 performs again the operation of Act 205 after a predetermined time, when determining that the second entry angle changing motor 604 does not make a predetermined amount of forward rotation (Act 205, No). The CPU 901 controls the second entry angle changing motor 604 to stop the forward rotation (Act 206), when determining that the second entry angle changing motor 604 makes the predetermined amount of forward rotation (Act 205, Yes). That is, the CPU 901 performs control such that the second entry angle becomes a predetermined value larger than 0 degrees, before the paper is conveyed from the inside of the second entry angle changing mechanism 60 into the conveying guide 803. Accordingly, the second entry angle changing mechanism 60 moves from the position C to the position D.

Thereafter, the CPU 901 controls the pair of paper discharge rollers 607 to rotate backward (Act 207). In Act 207, the CPU 901 performs control such that the paper is conveyed to the conveying guide 803 by switchback. In this operation, the conveying guide 601 is pressed to the eccentric cam 602 by the compression spring 603, such that vibration due to the operation of the pair of paper discharge rollers 607 is reduced. The CPU 901 controls the operation of Act 207, when the printing ratio of the first surface is larger than the predetermined reference value M (Act 203, No). That is, the second entry angle changing mechanism 62 is maintained at the position C.

The CPU 901 performs control such that the paper is conveyed into the conveying guide 803 by using the pair of conveying rollers 8031 and the pair of conveying rollers 8032 (Act 208). The CPU 901 acquires the detection information by the first sensor 8033 (Act 209). In Act 209, the CPU 901 determines that the paper is present in the detection area of the first sensor 8033, on the basis of the detection information by the first sensor 8033. That is, the CPU 901 determines that the rear end of the paper is completely conveyed from the inside of the conveying guide 601 into the conveying guide 803 in the conveying direction, when the first sensor 8033 cannot detect the paper.

The CPU 901 determines whether the printing ratio of the first surface is larger than the reference value M, on the basis of the image data (Act 210), when determining that the first sensor 8033 cannot detect the paper. The CPU 901 controls the second entry angle changing motor 604 to start backward rotation (Act 211), when the printing ratio of the first surface is larger than the reference value M (Act 210, Yes). In the first embodiment, the rotation of the second entry angle changing motor 604 in which the second entry angle changing mechanism 60 returns to the position C from the position D is determined as backward rotation. The CPU 901 determines whether the second entry angle changing motor 604 makes a predetermined amount of backward rotation (Act 212). The CPU 901 performs the operation of Act 211 again after a predetermined time, when determining that the second entry angle changing motor 604 does not make a predetermined amount of backward rotation (Act 212, No).

The CPU 901 controls the second entry angle changing motor 604 to stop the backward rotation (Act 213), when determining that the second entry angle changing motor 604 makes the predetermined amount of backward rotation (Act 212, Yes). That is, the second entry angle changing mechanism 60 returns to the position C from the position D. Thereafter, the CPU 901 controls the pair of paper discharge rollers 607 to stop the backward rotation (Act 214). The CPU 901 controls the operation of Act 214, when the printing ratio is larger than the reference value M (Act 210, No). That is, the second entry angle changing mechanism 60 is kept at the position C. Thereafter, the CPU 901 controls the pair of conveying rollers 607 to start forward rotation (Act 215).

As described above, the CPU 901 performs control such that the second entry angle becomes larger than when the printing ratio of the first surface is not larger than the reference value M, when the printing ratio of the first surface is larger than the reference value M. When the printing ratio of the first surface is not larger than the reference value M, the second entry angle changing mechanism 60 is maintained at the position C (the second entry angle is 0 degrees). This is because the amount of curl generated in the paper is small. The edge of the paper that is conveyed from the inside of the conveying guide 601 to into the conveying guide 803 is not stuck to the edge portion of the conveying guide 803.

Meanwhile, when the printing ratio of the first surface is larger than the reference value M, the CPU 901 performs control such that the second entry angle changing mechanism 60 moves from the position C to the position D (the second entry angle is a predetermined value). This is because the amount of curl generated in the paper is large. The edge of the paper that is conveyed from the inside of the second entry angle changing mechanism 60 into the conveying guide 803 is not stuck to the edge portion of the conveying guide 803. On the contrary, when the paper with a large amount of curl is conveyed from the inside of the second entry angle changing mechanism 60 at the position C into the conveying guide 803, the edge of the paper may be stuck to the edge portion of the conveying guide 803. According to the first embodiment, since the image forming apparatus 1 includes the second entry angle changing mechanism 60, the curled paper can be conveyed well. Therefore, in the image forming apparatus 1, bad printing due to bad conveying of the paper and jam do not occur.

FIG. 7 is a flowchart illustrating the control of the position of the first entry angle changing mechanism 30 in Act 110. Further, the timing when the CPU 901 controls Act 110 is not limited, for example, as long as it is before the front end of the paper of which only the first surface is the printed surface is conveyed from the conveying guide 803 to the first entry angle changing mechanism 30, after the paper of which both sides are non-printed surfaces is completely conveyed from the inside of the first entry angle changing mechanism 30 to the conveying belt 40.

First, the CPU 901 determines whether the printing ratio of the first surface is larger than the reference value M on the basis of the image data (Act 301). When the printing ratio is larger than the reference value M (Act 301, Yes), the CPU 901 controls the first entry angle changing motor 304 to start forward rotation (Act 302). In the first embodiment, the rotation of the first entry angle changing motor 304 in which the first entry angle changing mechanism 30 moves from the position A to the position B is determined as forward rotation. That is, the CPU 901 performs control such that the first entry angle is changed, by moving the eccentric cam 302. The CPU 901 determines whether the first entry angle changing motor 304 makes a predetermined amount of forward rotation (Act 303). The CPU 901 performs again the operation of Act 302 after a predetermined time, when determining that the first entry angle changing motor 304 does not make a predetermined amount of forward rotation (Act 303, No).

The CPU 901 controls the first entry angle changing motor 304 to stop the forward rotation (Act 304), when determining that the first entry angle changing motor 304 makes the predetermined amount of forward rotation (Act 303, Yes). That is, the CPU 901 performs control such that the first entry angle becomes a predetermined value larger than 0 degrees, before the paper is conveyed from the inside of the first entry angle changing mechanism 30 to the conveying belt 40. Therefore, the first entry angle changing mechanism 30 moves from the position A to the position B.

As described above, the CPU 901 performs control such that the first entry angle becomes larger than when the printing ratio of the first surface is not larger than the reference value M, when the printing ratio of the first surface is larger than the reference value M. When the printing ratio of the first surface is not larger than the reference value M, the first entry angle changing mechanism 30 is maintained at the position A (the first entry angle is 0 degrees). This is because the amount of curl generated in the paper is small. In the paper that is conveyed from the inside of the first entry angle changing mechanism 30 to the conveying belt 40, the edge is not stuck to any one of the inkjet heads 50C to 50Bk.

Meanwhile, when the printing ratio of the first surface is larger than the reference value M, the CPU 901 controls the first entry angle changing mechanism 30 to move from the position A to the position B (the first entry angle is a predetermined value). This is because the amount of curl generated in the paper is large. In the paper that is conveyed from the inside of the first entry angle changing mechanism 30 to the conveying belt 40, the front end is pressed to the conveying belt 40. Accordingly, curl of the paper is amended by the negative pressure chamber 403 and is absorbed to the conveying belt 40. That is, in the paper on the conveying belt 40, the edge does not float. Therefore, in the paper that is conveyed from the inside of the first entry angle changing mechanism 30 to the conveying belt 40, the edge is not stuck to any one of the inkjet heads 50C to 50Bk. On the contrary, when the paper with a large amount of curl is conveyed from the inside of the first entry angle changing mechanism 30 at the position A to the conveying belt 40, the front end of the paper is not pressed to the conveying belt 40. Accordingly, the paper is absorbed to the conveying belt 40 by the negative pressure chamber 403, with the edge floating. That is, the edge of the paper on the conveying belt 40 may float. Therefore, in the paper that is conveyed from the inside of the first entry angle changing mechanism 30 to the conveying belt 40, the edge may be stuck to any one of the inkjet heads 50C to 50Bk. According to the first embodiment, since the image forming apparatus 1 includes the first entry angle changing mechanism 30, the paper with curl can be conveyed well. Therefore, in the image forming apparatus 1, bad printing due to bad conveying of the paper and jam do not occur.

FIG. 8 is a flowchart illustrating the control of returning the first entry angle changing mechanism 30 from the position B to the position A in Act 112. Further, the timing when the CPU 901 performs the control shown in FIG. 8 is not limited, for example, as long as it is after the paper of which only the first surface is the printed surface is completely conveyed from the inside of the first entry angle changing mechanism 30 to the conveying belt 40. For example, the CPU 901 may perform the control shown in FIG. 8, after the printing unit 50 finishes printing the second surface that is the non-printed surface.

First, the CPU 901 determines whether the printing ratio of the first surface is larger than the reference value M, on the basis of the image data (Act 401). The CPU 901 controls the first entry angle changing motor 304 to start backward rotation (Act 402), when the printing ratio of the first surface is larger than the reference value M (Act 401, Yes). In the first embodiment, the rotation of the first entry angle changing motor 304 in which the first entry angle changing mechanism 30 returns to the position A from the position B is determined as backward rotation. The CPU 901 determines whether the first entry angle changing motor 304 makes a predetermined amount of backward rotation (Act 403). The CPU 901 performs again the operation of Act 402 after a predetermined time, when determining that the first entry angle changing motor 304 does not make a predetermined amount of backward rotation (Act 403, N0).

The CPU 901 controls the first entry angle changing motor 304 to stop the backward rotation (Act 404), when determining that the first entry angle changing motor 304 makes the predetermined amount of backward rotation (Act 403, Yes). In Act 404, the CPU 901 performs control such that the first entry angle is changed. That is, the first entry angle changing mechanism 30 returns to the position A from the position B. The CPU 901 finishes controlling the first entry angle changing mechanism 30, when the printing ratio of the first surface is not larger than the reference value M (Act 401, No). That is, the first entry angle changing mechanism 30 is kept at the position A.

Further, in the first embodiment, the CPU 901 keeps the second entry changing mechanism 60 at the position C, when the printing ratio of the first surface is the reference value M or less, in Act 203, but is not limited thereto. For example, the CPU 901 may control the second entry angle changing mechanism 60 such that the second entry angle is slightly larger than 0 degrees at the position C and smaller than the predetermined value at the position D, even though the printing ratio of the first surface is the reference value M or less. Similarly, the CPU 901, in Act 301, keeps the first entry angle changing mechanism 30 at the position A, when the printing ratio of the first surface is the reference value M or less, but is not limited thereto. For example, the CPU 901 may control the first entry angle changing mechanism 30 such that the first entry angle is slightly larger than 0 degrees at the position A and smaller than the predetermined value at the position B, even though the printing ratio of the first surface is the reference value M or less.

Further, in the first embodiment, the CPU 901, in Act 203, performs control such that the second entry angle changing mechanism 60 is switched to any one of the position C and the position D, in response to whether the printing ratio of the first surface is larger than the reference value M, but is not limited thereto. The CPU 901 may perform control such that the magnitude of the second entry angle changes gradually, in response to the magnitude of the printing ratio of the first surface that is the printed surface. Similarly, the CPU 901, in Act 301, performs control such that the first entry angle changing mechanism 30 is switched to any one of the position A and the position B in response to whether the printing ratio of the first surface is larger than the reference value M, but is not limited thereto. The CPU 901 may perform control such that the magnitude of the first entry angle changes gradually, in response to the magnitude of the printing ratio of the first surface that is the printed surface.

For example, the RAM 903 maintains second information showing the relationships between the amount of curl and the first entry angle and between the amount of curl and the second entry angle, in addition to the first information. The larger the amount of curl, the more the first entry angle and the second entry angle increase. The CPU 901 performs control such that the magnitudes of the first entry angle and the second entry angle are appropriately changed, in response to the magnitude of the printing ratio of the first surface that is the printed surface, with reference to the first information and the second information. In this case, the first entry angle and the second entry angle become the optimum magnitudes. Therefore, the image forming apparatus 1 can convey well even a piece of paper with curl.

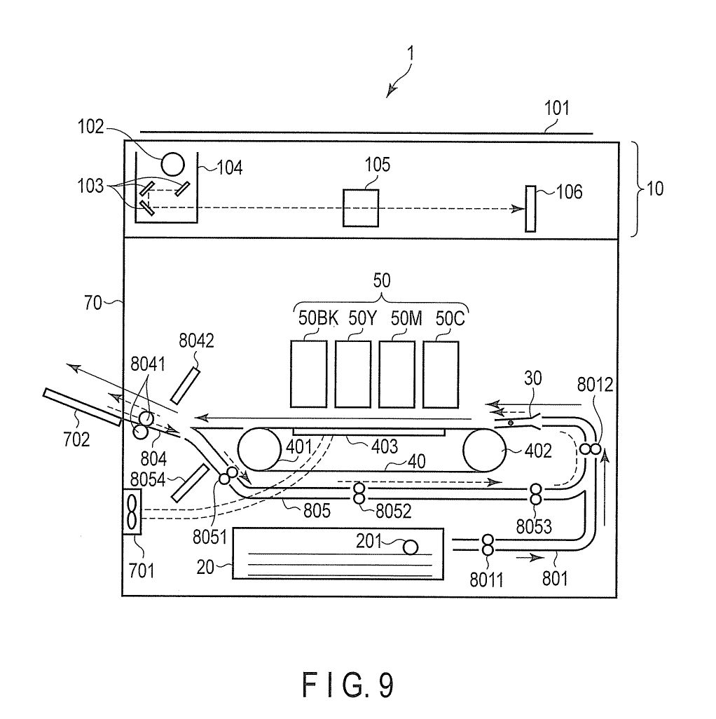

Next, an image forming apparatus 1 according to a second embodiment is described. FIG. 9 is a view of an image forming apparatus 1 according to the second embodiment, seen in the transverse direction. The image forming apparatus 1 includes an image reading unit 10, a paper cassette 20, a first entry angle changing mechanism 30, a conveying belt 40, a printing unit 50, a chassis 70, and a plurality of conveying guides 801, 804, and 805. In the description of the second embodiment, the same configurations as those in the first embodiment shown in FIG. 1 are given the same reference numerals.

In the second embodiment, the image forming apparatus 1, unlike the first embodiment, does not include the second entry angle changing mechanism 60. Further, in the second embodiment, a copy receiving tray 702 is disposed adjacent to the downstream of the conveying belt 40 and outside the chassis 70, unlike the first embodiment. The conveying guide 804 is positioned between the downstream of the conveying belt 40 and the copy receiving tray 702. The conveying guide 804 is fixed with respect to the image forming apparatus 1. The conveying guide 804 includes a pair of paper discharge rollers 8041 and a sensor 8042. The pair of paper discharge rollers 8041 has the same configuration as the pair of paper discharge rollers 607 described in the first embodiment. The sensor 8042 has the same configuration as the second sensor 608 described in the first embodiment.

The conveying guide 805 is connected to the conveying guide 804 at one end and with the conveying guide 801 at the other end. The conveying guide 805 is disposed from the downstream to the upstream of the conveying belt 40 through the portion under the conveying belt 40, as a conveying path for double-sided printing. The conveying guide 805 includes a pair of conveying rollers 8051, a pair of conveying rollers 8052, a pair of conveying rollers 8053, and a sensor 8054. The sensor 8054 has the same configuration as the second sensor 8033 described in the first embodiment.

The reason that the second embodiment does not include the second entry angle changing mechanism 60, unlike the first embodiment, is because the paper that is conveyed from the inside of the conveying guide 804 into the conveying guide 805 has an the upper surface that is the printed surface and a lower surface that is the non-printed surface, so that curl due to the weight of the paper itself is prevented from being generated. Therefore, the paper can be conveyed well between the mechanisms, even if the entry angle of the paper from the outlet of the conveying guide 804 with respect to the inlet of the conveying guide 805 is fixed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a printing unit; and
an entry angle changing mechanism which is disposed further along the upstream than the printing unit in a conveying direction and changes an entry angle of a piece of paper of which an upper surface is a non-printed surface and a lower surface is a printed surface, after printing on a first surface if printing on both sides are performed by the printing unit.

2. The apparatus of claim 1 wherein
the printing unit is an inkjet type.

3. The apparatus of claim 2 further comprising:
a control device which changes the entry angle of the paper of the entry angle changing mechanism.

4. The apparatus of claim 3 wherein
the entry angle changing mechanism includes an eccentric cam which changes the entry angle.

5. The apparatus of claim 4 wherein
the control device changes the entry angle by moving the eccentric cam.

6. The apparatus of claim 5 wherein
the control device performs control such that the entry angle is changed, before the paper is conveyed to the entry angle changing mechanism.

7. The apparatus of claim 3 wherein
the control device controls the entry angle based on a printing ratio for printing on the first surface.

8. The apparatus of claim 7 wherein
the control device performs control of changing such that the entry angle increases as the printing ratio for printing on the first surface gets larger.

9. The apparatus of claim 8 wherein
the controller changes the entry angle only if the printing ratio for printing on the first surface is larger than a reference value.

10. The apparatus of claim 2 wherein
the entry angle changing mechanism is disposed adjacent to the printing unit.

11. The apparatus of claim 2 further comprising
a turning-over mechanism which turns over the paper.

12. The apparatus of claim 11 wherein
the entry angle changing mechanism is disposed inside the turning-over mechanism.

13. The apparatus of claim 1 wherein
the entry angle changing mechanism includes a motor, a gear train connected to the motor, an eccentric cam connected to the gear train, a conveying guide connected to the eccentric cam, and a spring disposed opposite to the eccentric cam, with the conveying guide therebetween.

14. A method of forming an image comprising:
giving an instruction for printing on a first surface of a piece of paper;
conveying the paper after printing on the first surface of the paper;
changing an entry angle of the paper of which an upper surface is a non-printed surface and a lower surface is a printed surface, before printing on a second surface of the paper is performed, after printing on the first surface of the paper is performed; and
giving an instruction for printing on the second surface of the paper.

15. The method of claim 14 wherein
the instruction for printing is an instruction for discharging ink.

16. The method of claim 15 comprising
controlling the entry angle based on a printing ratio for printing on the first surface.

17. The method of claim 16 comprising
changing such that the entry angle increases, as the printing ratio for printing the first surface gets larger.

18. The method of claim 17 comprising
changing the entry angle only if the printing ratio for printing on the first surface is larger than a reference value.
